(19) United States
(12) Patent Application Publication
(10) Pub. No.: US 2026/0237280 A1
(43) Pub. Date: Aug. 13, 2026

(54) Fall Detection and Alert Apparatus

(71) Applicant: Oliver Edmondson, Grand Prairie, TX (US)

(72) Inventor: Oliver Edmondson, Grand Prairie, TX (US)

(21) Appl. No.: 19/452,496

(22) Filed: Jan. 19, 2026

Related U.S. Application Data
(60) Provisional application No. 63/757,887, filed on Feb. 13, 2025.

(51) Int. Cl. G08B 21/02; A62B 35/00; A62B 35/04; G08B 3/10; G08B 25/10

(52) U.S. Cl. CPC G08B 21/02; A62B 35/0025; A62B 35/04; G08B 3/10; G08B 25/10

(57) ABSTRACT

A fall detection and alert apparatus that comprises an elongated lanyard strap made from high-tensile webbing material having a first end attachable to an anchor point and a second end connectable to a full-body safety harness is disclosed. An alarm module is disposed (i.e., connected) along the strap and includes a speaker, power source, test button, and a detachable activation pin. The pin is tethered to the lanyard and automatically removed under tension from a fall, closing an internal circuit to activate the speaker and emit an audible alert. A shock-absorbing member is stitched to the lanyard and configured to elongate under load. The alarm module may also include a wireless transmitter to send remote alerts. The invention enhances fall protection systems by enabling real-time audio and remote notifications of fall events.

### CROSS-REFERENCE TO RELATED APPLICATION

The present application claims priority to, and the benefit of, U.S. Provisional Application No. 63/757,887 which was filed on February 13, 2025 and is incorporated herein by reference in its entirety.

### FIELD OF THE INVENTION

The present invention generally relates to safety equipment and fall protection systems. More specifically, the present invention relates to wearable fall detection and alert apparatus configured to both arrest a fall and automatically notify others when a fall incident occurs. The invention comprises an elongated lanyard strap constructed from high-tensile strength webbing material, a shock-absorbing member configured to elongate under sudden load, and an alarm module mounted along the strap. The alarm module includes a speaker, test button, internal circuit, and a detachable activation pin tethered to the lanyard. When the user falls, the tension in the lanyard pulls the pin from the alarm housing, thereby activating the speaker to emit a loud audible signal. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals such as construction workers, warehouse personnel, maintenance staff, and more are required to work at elevated work areas. Falls from such elevated work areas continue to be one of the leading causes of serious injury and fatality in occupational and recreational environments. Individuals use safety harnesses and fall arrest systems to prevent falls, but all the conventional systems lack automatic notification when a fall incident occurs.

In many cases, workers may become suspended in a harness after a fall, unable to move or call for help. If no other personnel are immediately nearby or aware of the incident, the fallen individual may remain unassisted for a prolonged period, leading to severe injury, trauma, or death.

Similarly, individuals engaged in outdoor activities such as hunting, mountain climbing, hiking, or tree stand use, may also experience falls or other medical emergencies in remote or isolated areas. Such individuals are often alone or beyond the range of verbal communication, making it difficult or impossible to summon help in a timely manner. Accordingly, individuals desire a fall protection solution that not only prevents impact injuries through harnessing but also provides an automated method for alerting others immediately when a fall occurs.

Therefore, there exists a long-felt need in the art for a fall protection apparatus that prevents injury from falls and alerts others immediately when a fall occurs. There is a long-felt need for a device that integrates with standard safety harness systems and lanyards while providing automated alert capabilities without requiring manual input. Additionally, there is a long-felt need for a safety device that reduces rescue response times and prevents suspended workers from remaining unnoticed or unattended for extended periods. Furthermore, there is a need for a system that is durable, reliable, easy to test, and adaptable for use in industrial, commercial, and outdoor recreational environments. Finally, there is a long-felt need for a device that automatically generates an audible alert when a fall occurs, alerting nearby individuals that someone may be stuck in a harness.

The subject matter disclosed and claimed herein, in one embodiment, comprises a fall detection and alert apparatus that includes an elongated lanyard strap made from high-strength webbing material such as nylon, polyester, or aramid fiber. The lanyard includes a first end attachable to an overhead anchor point using a mechanical fastener such as a carabiner or snap hook, and an opposite second end terminating in a harness connection assembly designed to attach to the dorsal D-ring of a full-body safety harness. An alarm module is disposed (i.e., connected) along the length of the lanyard and comprises a housing, speaker, detachable activation pin, test button, and an internal electronic circuit. In the event of a fall, tension in the lanyard pulls the activation pin from the alarm module, triggering the circuit and activating the speaker to emit a loud audible al.

In one embodiment, the alarm module is further equipped with a wireless transmitter, such as a Bluetooth or RF module, which sends a remote signal to a receiver, notifying supervisors or rescue personnel of the fall in real-time. The alarm module is made from impact-resistant plastic such as ABS or polycarbonate, and the speaker is configured to produce a sound output exceeding 90 decibels (i.e., between 90 and 120 decibels) to ensure it is heard in loud or open environments.

A test button on the housing enables the user to manually verify operational readiness before beginning elevated work.

In this manner, the fall detection and alert apparatus of the present invention addresses longstanding challenges in occupational and recreational fall protection. The invention provides a dual-function system that not only helps arrest a fall but also actively notifies others that an incident has occurred. The apparatus improves rescue timelines and reduces the risk of suspension trauma, unconsciousness, or death caused by post-fall isolation. The device is modular, and the rugged design makes the apparatus suitable for diverse applications, including construction, warehousing, tree stand hunting, and mountaineering.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fall detection and alert apparatus. The apparatus comprises a lanyard strap formed from a high-tensile strength webbing material, the lanyard strap has a first end and a second end, the first end is configured to be operatively connected to an overhead anchor point via a mechanical fastener, the second end couple with a dorsal D-ring of a full-body safety harness, an alarm module is disposed (i.e., connected) along the length of the lanyard strap, the alarm module comprises a speaker configured to emit an audible alarm signal, a detachable activation pin is removably housed in the alarm module, a pin-retaining tether couples the activation pin to the lanyard strap, and a test button is configured to activate the speaker to verify operational status, wherein a fall event causes tension in the lanyard strap that pulls the activation pin from the alarm module, causing the speaker to emit the audible alarm signal.

In another embodiment, an alarm module for use with a personal fall arrest system is disclosed. The alarm module includes a speaker disposed within the housing and configured to emit an audible alert signal between 90 and 120 decibels, a power source is configured as a replaceable or rechargeable battery pack operatively coupled to the speaker, a printed circuit board (PCB) includes an internal trigger circuit electrically coupled to the speaker and power source, a test button is disposed on the housing and electrically connected to the PCB to enable manual testing of the speaker, a detachable mechanical activation pin is removably positioned within the housing, wherein removal of the activation pin closes the internal trigger circuit and causes the speaker to emit the audible alert.

In one embodiment, a method for detecting a fall and alerting others using a fall detection and alert apparatus is disclosed. The method comprises the steps of securing a first end of a lanyard strap to an overhead anchor point, securing a second end of the lanyard strap to a dorsal D-ring of a full-body safety harness worn by a user, disposing an alarm module along the lanyard strap above the user's head, the alarm module comprises a housing, a speaker, a power source, a printed circuit board, and a removable mechanical activation pin, inserting the activation pin into the housing such that the speaker is in a standby state, detecting a fall event by applying a sudden downward force to the lanyard strap, pulling the activation pin from the alarm module in response to the fall event, automatically closing the circuit inside the alarm module, activating the speaker to emit an audible alert signal, and transmitting a wireless alert signal to a remote receiver to indicate a fall has occurred.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of a fall detection and alert apparatus of the present invention in accordance with the disclosed structure;

FIG. 2 illustrates a block diagram showing different electronic components included in the alarm module in accordance with one embodiment of the present invention;

FIG. 3 illustrates a flow chart showing steps in use of the fall alarm safety device of the present invention in accordance with the disclosed structure; and

FIG. 4 illustrates an elevation view of a worker using the fall alarm safety device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fall protection apparatus that prevents injury from falls and alerts others immediately when a fall occurs. There is a long-felt need for a device that integrates with standard safety harness systems and lanyards while providing automated alert capabilities without requiring manual input. Additionally, there is a long-felt need for a safety device that reduces rescue response times and prevents suspended workers from remaining unnoticed or unattended for extended periods. Furthermore, there is a need for a system that is durable, reliable, easy to test, and adaptable for use in industrial, commercial, and outdoor recreational environments. Finally, there is a long-felt need for a device that automatically generates an audible alert when a fall occurs, alerting nearby individuals that someone may be stuck in a harness.

The present invention, in one exemplary embodiment, is a method for detecting a fall and alerting others using a fall detection and alert apparatus. The method comprises the steps of securing a first end of a lanyard strap to an overhead anchor point, securing a second end of the lanyard strap to a dorsal D-ring of a full-body safety harness worn by a user, disposing an alarm module along the lanyard strap above the user's head, the alarm module comprises a housing, a speaker, a power source, a printed circuit board, and a removable mechanical activation pin, inserting the activation pin into the housing such that the speaker is in a standby state, detecting a fall event by applying a sudden downward force to the lanyard strap, pulling the activation pin from the alarm module in response to the fall event, automatically closing the circuit inside the alarm module, activating the speaker to emit an audible alert signal, and transmitting a wireless alert signal to a remote receiver to indicate a fall has occurred.

Reference will now be made in detail to the present preferred embodiments of the invention, examples of which are illustrated in the accompanying drawings. Wherever possible, the same reference numerals are used in the drawings and the description to refer to the same or like parts.

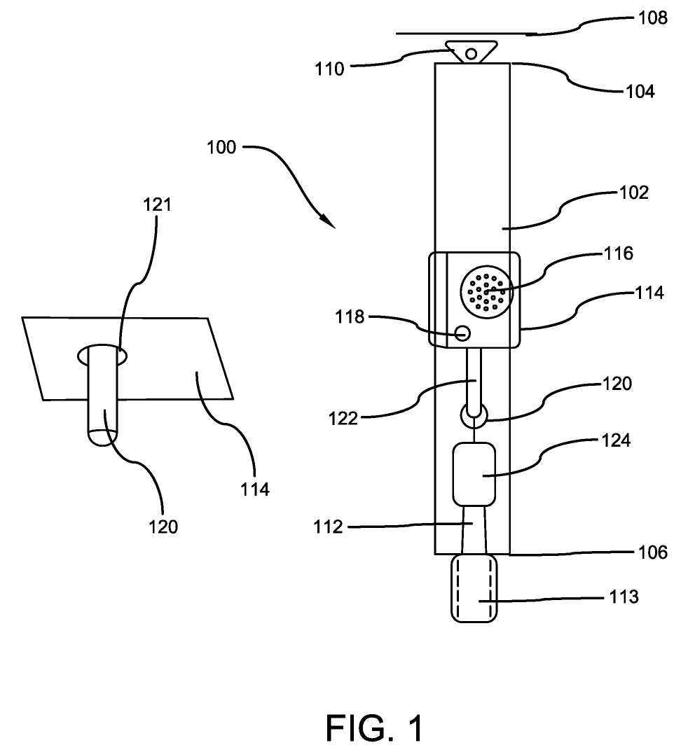

Referring initially to the drawings, FIG. 1 illustrates a perspective view of fall detection and alert apparatus of the present invention in accordance with the disclosed structure. The fall detection and alert apparatus 100 of the present invention is designed to both prevent injury from falls and alert other users immediately when a fall incident occurs. The apparatus 100 can be used in warehouses and factories using elevated lifts or platforms, construction sites with overhead work areas, and in outdoor activities like mountain climbing or hiking. More specifically, the apparatus 100 includes an elongated lanyard strap 102. The elongated lanyard strap 102 can be made from high-tensile strength webbing material selected from the group consisting of nylon, polyester, or aramid fiber.

The elongated lanyard strap 102 has a first end 104 and an opposite second end 106. The first end 104 is operatively connected to an anchor point 108 via a mechanical fastener 110 such as a mechanical carabiner or snap hook for suspending the apparatus 100 therefrom. The opposite second end 106 terminates in a harness connection assembly 112 adapted to couple with a dorsal D-ring of a full-body safety harness 113.

An alarm module 114 is disposed (i.e., connected) along the length of the elongated lanyard strap 102. The alarm module 114 is configured to detect a fall and generate an alarm to alert other users immediately when a fall incident occurs. The alarm module 114 includes a speaker 116 such as a piezoelectric speaker for generating an audible alert. A manually operable test button 118 is configured for initiating a test alarm signal and verifying operational readiness of the apparatus 100. A detachable activation pin 120 is included in the apparatus 100 and is removably housed in the alarm module 114. In the event of a fall, the pin 120 is pulled from the alarm module 114 through an aperture 121 and completes an electrical circuit, thereby actuating the speaker 116 to generate an audible alert signal (in the present embodiment, the pin 120 is shown in the pulled state). The activation pin 120 is connected to the lanyard 102 via a pin-retaining tether 122.

A shock-absorbing member 124 is located distal to the alarm module 114 and is stitched to the lanyard strap 102. The shock-absorbing member 124 is in the form of an energy-absorbing fill pack made of layered webbing material enclosed in a rupture-resistant sleeve. The shock-absorbing member 124 elongates under sudden tension loads exceeding a threshold force, such as when a user falls while using the apparatus 100. The harness connection assembly 112 can be in the form of a D-ring, shackle, or carabiner that facilitates secure attachment to a fall protection harness.

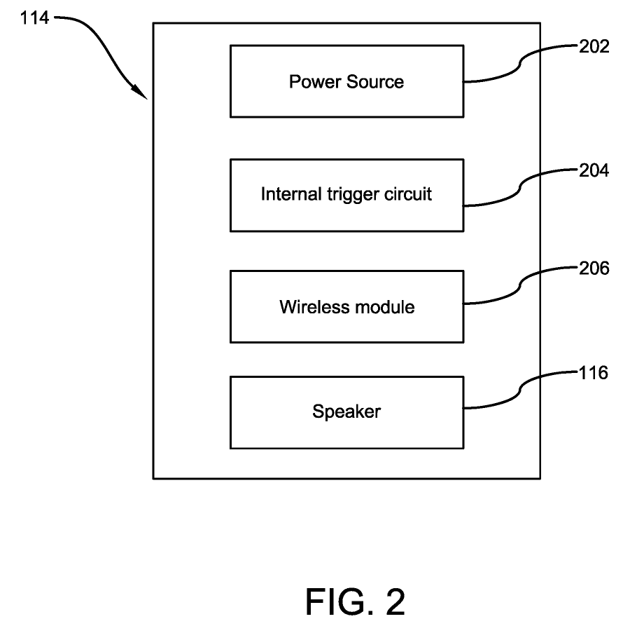

FIG. 2 illustrates a block diagram showing different electronic components included in the alarm module in accordance with one embodiment of the present invention. The alarm module 114 is made from Impact-resistant ABS plastic, polycarbonate, or high-density polyethylene (HDPE). The alarm module 114 is preferably rectangular or square and has a sealed structure. The speaker 116 is configured to produce sound (i.e., audible alert) above 90 decibels (i.e., between 90 and 120 decibels) in a continuous tone when activated, thereby alerting personnel nearby that a fall event has occurred. The apparatus 100 could also issue an alert in the form of an electronic notification to, for example, a cell phone.

The alarm module 114 includes a replaceable or rechargeable power source 202 such as lithium-ion or alkaline battery pack. The power source 202 provides electric power to the speaker and test functions of the alarm module 114. An internal trigger circuit 204 is in the form of a low voltage printed circuit board (PCB) and is configured to close the circuit to activate the speaker 116. The internal trigger circuit 204 is operatively connected to the detachable activation pin 120 and activates the speaker 116 upon automatic or manual removal of the pin 120.

The alarm module 114 also includes a wireless module 206 such as Bluetooth or RF module to automatically transmit a remote signal to a remote device for alerting a user. It should be noted that the alarm module 114 is positioned such that the alarm module 114 lies above the head of a user when the user uses the apparatus 100.

It should be noted that a sudden downward pull caused by a fall, such as when a user falls, place tension in the lanyard 102 and automatically pulls the mechanical pin 120 from the alarm module 114. The pulling of the mechanical pin 120 action completes the internal circuit 204, thereby activating the speaker 116 that emits a loud audible alert. The sound notifies others in the vicinity that a fall has occurred and that immediate assistance may be needed.

The apparatus 100 also addresses the problem of post-fall isolation where a fallen worker may remain suspended in a harness without being noticed. The integrated alarm reduces response time by alerting nearby personnel, thereby preventing the individual from being left hanging in a dangerous position for extended periods.

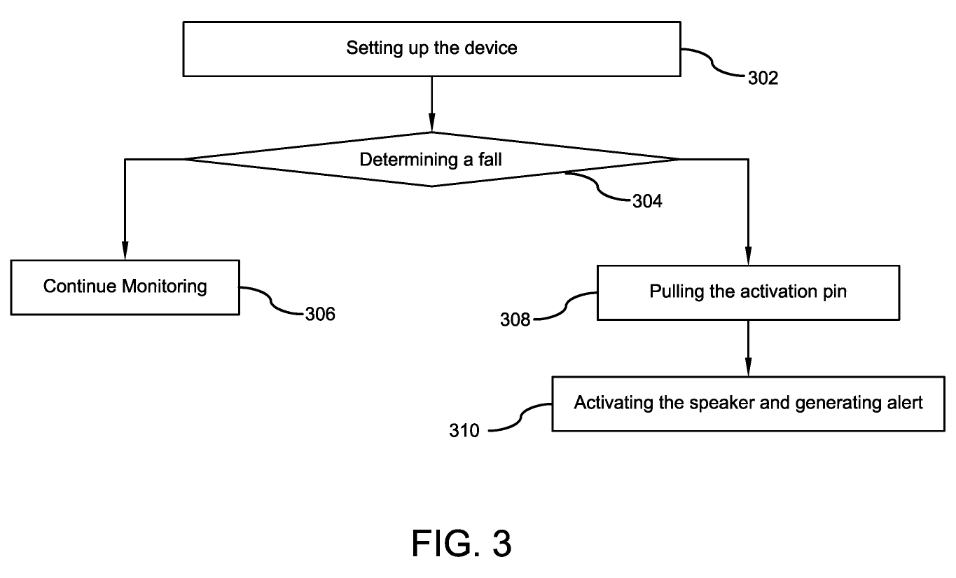

FIG. 3 illustrates a flow chart showing steps in use of the fall alarm safety device of the present invention in accordance with the disclosed structure. Initially, a user wears a safety harness to which the device/apparatus is attached and connects the first end 104 of the lanyard 102 to an overhead anchor point (Step 302). When the safety device 100 is connected to the anchor point, the mechanical pin 120 is in the armed state i.e. inserted into the alarm module 114.

Then, the alarm module 114 determines or detects a fall (Step 304). It should be noted that once the user begins elevated operations, the safety device 100 remains in standby unless a fall event occurs. If no fall is detected, the system continues monitoring passively (Step 306). If a fall is detected, such as by the sudden downward force exerted on the lanyard, then tension is applied on the lanyard 102 and the activation pin 120 is pulled (Step 308). Upon activation of the pin 120, the speaker 116 is activated, emitting a loud audible alert (Step 310).

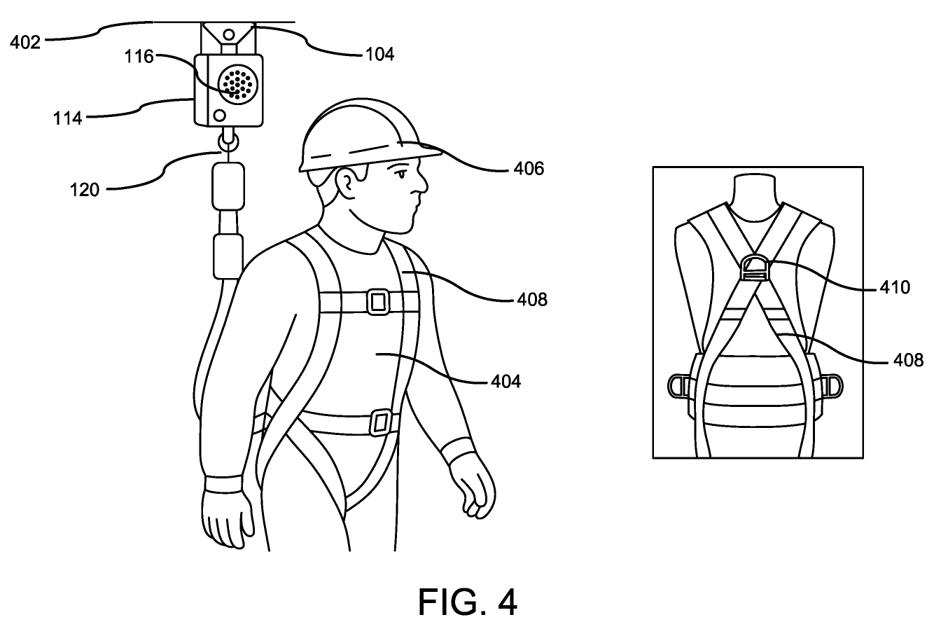

FIG. 4 illustrates an elevation view of a worker using the fall alarm safety device of the present invention in accordance with the disclosed structure. As illustrated, the top end 104 is fastened to the anchor point bracket 402 wherein the anchor point bracket 402 can be secured to a ceiling beam, overhead rafter, platform rail, or any other similar structure. The lanyard 102 is vertically oriented and extends downward along the back of the worker 404. The lanyard 102 is fabricated from a durable webbing material such as woven nylon or aramid fiber and is dimensioned to support fall arrest loads. The alarm device 114 is positioned above the user’s head level 406. The lanyard 102 connects to the shock-absorbing strap member 124 and terminates with a connection to the standard full-body harness 408 worn by the worker 404. Specifically, the lanyard 102 is connected at the dorsal D-ring region 410 located between the shoulder blades on the rear of the harness 408. The connection enables fall forces to be properly distributed across the torso and upper legs, reducing the risk of injury.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fall alarm safety device, “fall detection and alert apparatus”, “fall safety device”, “apparatus”, and “device” are interchangeable and refer to the fall detection and alert apparatus 100 of the present invention.

Notwithstanding the forgoing, the fall detection and alert apparatus 100 of the present invention can be of any suitable configuration as is known in the art without affecting the overall concept of the invention, provided that it accomplishes the above stated objectives. One of ordinary skill in the art will appreciate that the fall detection and alert apparatus 100 as shown in the FIGS. are for illustrative purposes only, and that many other configurations of the fall detection and alert apparatus 100 are well within the scope of the present disclosure. Although the dimensions of the fall detection and alert apparatus 100 are important design parameters for user convenience, the fall detection and alert apparatus 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fall detection and alert apparatus comprising:
a lanyard strap having a first end and an opposing second end;
a safety harness;
an anchor point; and
an alarm module having a detachable activation pin;
wherein said first end operatively connected to said anchor point;
wherein said second end terminating in a harness connection assembly;
wherein said harness connection assembly coupled to a ring of said safety harness;
wherein said alarm module connected along a length of said lanyard strap;
wherein said alarm module having a speaker for generating an audible alert;
wherein said detachable activation pin connected to said lanyard strap with a pin-retaining tether; and
further wherein said detachable activation pin separable from said alarm module when a user of said alert apparatus moves a distance from said anchor point and pulls said pin-retaining tether and actuates said speaker.

2. The fall detection and alert apparatus of claim 1, wherein said alert apparatus moves said distance when the user falls.

3. The fall detection and alert apparatus of claim 2, wherein when said detachable activation pin separated from said alarm module an electrical circuit is completed to actuate said speaker and said audible alert.

4. The fall detection and alert apparatus of claim 3, wherein said lanyard strap having a shock-absorbing member including a layered webbing material for elongating under tension loads when the user falls.

5. The fall detection and alert apparatus of claim 4, wherein said harness connection assembly selected from the group consisting of a D-ring, a shackle, and a carabiner.

6. The fall detection and alert apparatus of claim 5, wherein said audible alert has a decibel level between 90 and 120 decibels in a continuous tone.

7. The fall detection and alert apparatus of claim 6, wherein said lanyard strap having a high-tensile strength webbing material selected from the group consisting of a nylon, a polyester, and an aramid fiber.

8. The fall detection and alert apparatus of claim 7, wherein said ring comprising a dorsal D-ring.

9. The fall detection and alert apparatus of claim 8, wherein said alarm module having a manually operable test button for initiating a test alarm signal and verifying operational readiness of said alert apparatus.

10. The fall detection and alert apparatus of claim 9, wherein said anchor point having a mechanical fastener selected from the group consisting of a mechanical carabiner and a snap hook for suspending said alert apparatus therefrom.

11. The fall detection and alert apparatus of claim 1, wherein said alarm module having a wireless module to transmit a remote signal to a remote device for alerting another.

12. A fall detection and alert apparatus comprising:
a lanyard strap having a first end and an opposing second end;
a safety harness;
an anchor point; and
an alarm module having a detachable activation pin;
wherein said first end operatively connected to said anchor point;
wherein said second end terminating in a harness connection assembly;
wherein said harness connection assembly coupled to a ring of said safety harness;
wherein said alarm module connected along a length of said lanyard strap;
wherein said alarm module having a speaker for generating an audible alert;
wherein said detachable activation pin connected to said lanyard strap with a pin-retaining tether;
wherein said detachable activation pin separable from said alarm module when a user of said alert apparatus moves a distance from said anchor point and pulls said pin-retaining tether and actuates said speaker; and
further wherein said audible alert has a decibel level between 90 and 120 decibels in a continuous tone.

13. The fall detection and alert apparatus of claim 12, wherein said alert apparatus moves said distance when the user falls.

14. The fall detection and alert apparatus of claim 13, wherein when said detachable activation pin separated from said alarm module an electrical circuit is completed to actuate said speaker and said audible alert.

15. The fall detection and alert apparatus of claim 14, wherein said lanyard strap having a shock-absorbing member including a layered webbing material for elongating under tension loads when the user falls.

16. The fall detection and alert apparatus of claim 14, wherein said lanyard strap having a high-tensile strength webbing material selected from the group consisting of a nylon, a polyester, and an aramid fiber.

17. The fall detection and alert apparatus of claim 14, wherein said alarm module having a wireless module to transmit a remote signal to a remote device for alerting another.

18. A method for detecting a fall and generating an audible alert, the method comprising the steps of:
providing a lanyard strap having a first end and an opposing second end, a safety harness, an anchor point, and an alarm module having a detachable activation pin, wherein said alarm module having a speaker for generating an audible alert;
operatively connecting said first end to said anchor point;
terminating said second end in a harness connection assembly;
coupling said harness connection to said safety harness;
connecting said alarm module along a length of said lanyard strap;
connecting said detachable activation pin to said lanyard strap with a pin-retaining tether; and
separating said detachable activation pin from said alarm module when a user of said alert apparatus moves a distance from said anchor point and pulls said pin-retaining tether and actuates said speaker and said audible alert.

19. The method for detecting a fall and generating an audible alert of claim 18, wherein said alert apparatus moves said distance when the user falls, and further wherein when said detachable activation pin separated from said alarm module an electrical circuit is completed to actuate said speaker and said audible alert.

20. The method for detecting a fall and generating an audible alert of claim 19, wherein said alarm module having a wireless module to transmit a remote signal to a remote device for alerting another.
